(19) United States
(12) Patent Application Publication
(10) Pub. No.: US 2006/0254366 A1
(43) Pub. Date: Nov. 16, 2006

(54) Sensor and sensor array for monitoring a structure

(76) Inventors: Caroline Williamson, Hampshire (GB); Lisa Fixter(nee Humberstone), Hampshire (GB); Andrew Clarke, Hampshire (GB)

Correspondence Address: NIXON & VANDERHYE, PC, 901 NORTH GLEBE ROAD, 11TH FLOOR, ARLINGTON, VA, 22203, US

(21) Appl. No.: 10/569,578

(22) PCT Filed: Sep. 7, 2004
(86) PCT No.: PCT/GB04/03808

§ 371 Date: Feb. 28, 2006

(30) Foreign Application Priority Data
Sep. 9, 2003 (GB) 0321058.0

(51) Int. Cl. G01M 5/00

(52) U.S. Cl. 73/786

(57) ABSTRACT

A sensor for monitoring a structure, said sensor comprising a network of interconnected electrical pathways, wherein an electrical property of the pathways (preferably at least one of the impedance, the capacitance, the inductance and the resistance) is arranged in use to be responsive to a change in a predetermined physical property of the structure. The sensor network may comprises a first sub-network of pathways and a second sub-network of pathways, the first and second sub-networks being superposed. A method of monitoring the structural health of a structure having the aforementioned sensor comprising the steps of monitoring an electrical property of the sensor, measuring changes in the monitored electrical property in order to identify and locate a structural event across the sensor, assessing the level of damage by comparing the measured change in the electrical property with that for known strain events, and sending an alert in the event the damage is assessed as significant.

This invention relates to the field of structural health monitoring, in particular, but not limited to, the structural monitoring of composite structures.

Many in service structures require some form of monitoring to prolong their life span or prevent catastrophic failure. Visual inspection techniques are often inadequate to identify damage invisible to the naked eye (for example, damage that has resulted from an event on the surface of an article can often manifest itself to the rear of an article) and are also time consuming and expensive.

A variety of automated health monitoring systems exist for structures many of which are based on the use of a large array of strain gauges. U.S. Pat. No. 6,370,964 uses an array of piezoelectric actuators and fibre optic sensors embedded within a laminated composite structure. U.S. Pat. No. 6,399,939 uses a number of piezoceramic fibre sensors which are connected to form a sensor array.

There are however a number of disadvantages associated with the use of strain gauge type sensor arrays. Such systems require a large number of strain gauges to be mounted on the structure in order to detect structural changes at useful resolutions and this is time consuming and expensive. Furthermore the large number of sensor devices has an associated increase in weight of the overall structure. Strain gauges are also local monitoring devices which can result in areas of the structure which are unmonitored. Such localised devices are described in GB 2360361 A, U.S. Pat. No. 5,375,474 A, EP 0899551 A1, U.S. Pat. No. 5,404,124 A, DE 19826411 A1 and EP 0469323 A3 for example.

Other health monitoring systems exist which utilise optical fibres to monitor a structure. Such a system is disclosed in U.S. Pat. No. 4,836,030. Disadvantages associated with optical fibre based systems include the fragility of optical fibres and the general requirement that the fibres need to be embedded within the structure which can reduce structural strength and also makes retrofitting of such devices expensive.

It is therefore an object of the present invention to provide a sensor for monitoring a structure which overcomes or substantially mitigates the problems associated with prior art structural health monitoring systems.

According to a first aspect of the present invention there is provided a sensor for monitoring a structure comprising a network of interconnected electrical pathways, wherein an electrical property of the pathways is arranged in use to be responsive to a change in a predetermined physical property of the structure.

The invention provides for an electrical monitoring network which is either bonded to the surface of a structure or alternatively is embedded within it. The sensor enables the performance of the structure to which it is associated to be monitored by a change in an electrical property of the network. A number of different physical properties could be monitored by the sensor, for example, a change in an electrical property can be related to a corresponding strain or load or alternatively to changes in moisture content.

Preferably, the electrical property comprises at least one of the impedance, the capacitance, the inductance and the resistance of the pathways.

Conventional moisture sensors, see for example GB 2034896, typically comprise point localised devices having at least two discrete electrical conductive tracks separated by a material whose resistance varies in response to the amount of moisture absorbed by the material. In contrast, the present sensor is capable of sensing over a large area and comprises a network having electrical pathways connected together within the network by a plurality of interconnections.

Preferably however the sensor is responsive to changes in the strain on a structure.

The network comprises an arrangement of interconnected electrical pathways which can be arranged in any suitable geometry. Conveniently the network takes the form of a grid arrangement. The proximity of neighbouring pathways can be varied according to the required resolution of the system. The grids can be in a single or multilayered arrangement with common connections and can incorporate temperature compensation within the design. This makes the present invention distinct from GB 2198237 A or U.S. Pat. No. 537,944 A in that it relies on electrical interconnection of the entire grid design, rather than the electrical isolation of one orientation from another as stressed in U.S. Pat. No. 537,944, for example.

The sensor according to the present invention has the advantage that it can cover the whole structure to be monitored and it can be used to monitor either the whole structure or just critical areas. It can be attached to the surface of an existing surface and so is suitable for retro-fitting. Furthermore, in contrast to prior art sensors, it does not rely on the use of individual strain gauges and so is easy to install.

Conveniently, the network of electrical pathways can comprise a first sub-network of pathways and a second sub-network of pathways which are superposed. If the pathway sub-networks are both periodic and the periodicity of the two sub-networks is different then the structure can be monitored at a low resolution until a structural event occurs (by monitoring only the larger periodic pathway sub-network) and then the sensor can be interrogated (using the smaller periodic pathway sub-network) to locate the structural event with greater resolution. This feature conveniently reduces the processing load on any monitoring software associated with the sensor. The first and second sub-networks may be arranged to be electrically isolated from one another. Alternatively, the first and second sub-networks may be connected together, for example at the points where the pathways of the first and second sub-networks intersect, or merely at the external connections to the sub-networks.

Preferably, the pathways within the sensor are arranged as a plurality of intersecting rows and columns. Conveniently, the rows are arranged substantially perpendicular to the columns. Advantageously, the pathway within each row is connected electrically to the pathway within each column at the intersections thereof.

Conveniently the sensor can be mounted onto a substrate to facilitate attachment to a pre-existing structure. Where the sensor comprises first and second sub-networks, the first sub-network may be arranged on a first surface of the substrate and the second sub-network may be arranged on a second surface of the substrate. Alternatively, the sensor can be incorporated into the body of a new structure.

According to a further aspect of the present invention there is provided a sensor array for monitoring a structure comprising a sensor according to a first aspect of the invention and a signal processing means arranged in use to monitor an electrical property of the pathways, the processing means being electrically connected to each end of each electrical pathway.

In this further aspect of the invention the sensor according to the first aspect of the invention is electrically connected to signal processing means which measures the electrical property of the pathways of the network. Any change in the electrical property following a structural event (e.g. an impact or deflection) can be related to a strain or load on the structure. By utilisation of a suitable geometry for the pathways of the network the signal processing means can locate the region of the sensor which has experienced the structural event. For example, a convenient network geometry would be a grid network. The signal processing means can then interrogate different pathways within the network in order to locate the point of origin of the structural event.

Conveniently, in order to reduce the processing load on the signal processing means, only a sub-set of the available electrical pathways are continuously monitored. Once a change in the electrical property of the sub-set of pathways is detected an initial, low resolution, assessment of location of the structural event can be made. The remaining pathways can then be interrogated to more accurately pinpoint the location.

Conveniently, the signal processing means can assess changes in the electrical property of the sensor in order to determine whether damage to the structure has occurred. An assessment of the implication of this damage on the effect of the integrity of the structure can conveniently be made with reference to a look up table of the electrical property-strain events that includes information on weighting functions, determined through the identification of critical areas of the structure.

The sensor array of the further aspect of the present invention is particularly suitable for monitoring the structural health of composite materials and preferably the sensor or the array is embedded within such materials during manufacture.

Composite materials are increasingly being used in the aircraft industry and the present invention can be used to monitor the structural integrity of any aircraft components incorporating such materials.

Conveniently, when used within an aircraft structure, the electrical pathways can be designed to additionally function as a lightning conductor.

As an alternative the sensor array of the further aspect of the present invention can be used as a fit-for-use indicator for products like mobile phones, helmets, emergency equipment, gas cylinders, pressurised containers wherein it indicates whether the articles have undergone a damage event which makes them unsafe to use.

In a still further aspect of the present invention there is provided a method of monitoring the structural health of a structure, having a sensor according to the first aspect of the present invention, comprising the steps:
(i) monitoring an electrical property of the sensor,
(ii) measuring changes in the monitored electrical property in order to identify a structural event across the sensor,
(iii) assessing the level of damage by comparing the measured change in the electrical property with that for known strain events, preferably related to critical areas of the structure,
(iv) sending an alert in the event the damage is assessed as significant.

Upon detection of a change in resistance following a structural event across the sensor, the method may also comprise the additional step of measuring the electrical property across specific electrical pathways in order to locate the structural event.

In a preferred embodiment, the method comprises iteratively selecting specific electrical pathways arranged progressively closer to one another within the sensor in order to locate the structural event.

Advantageously, the monitored electrical property comprises the resistance of the sensor.

Embodiments of the present invention will now be described, by way of example only, with reference to the accompanying drawings, in which

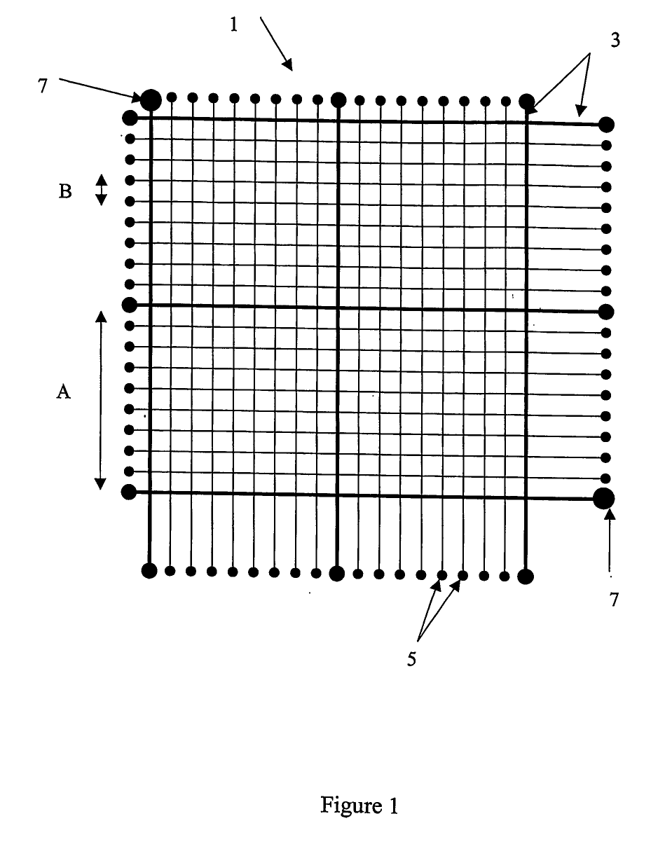

FIG. 1 shows a schematic of a sensor according to the present invention,

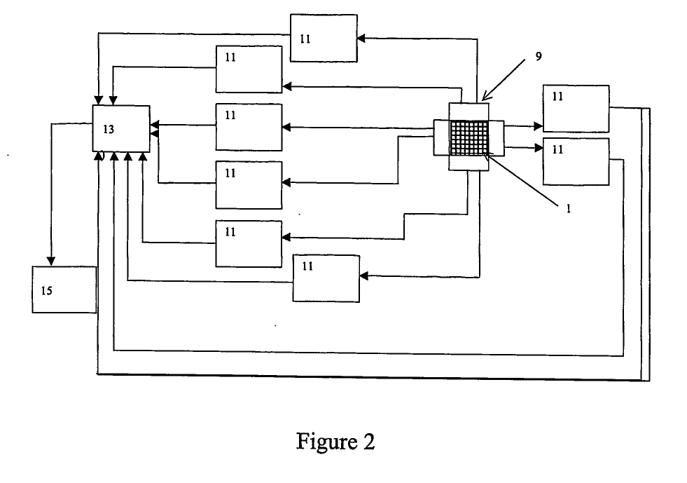

FIG. 2 shows a sensor array according to the present invention incorporating the sensor of FIG. 1,

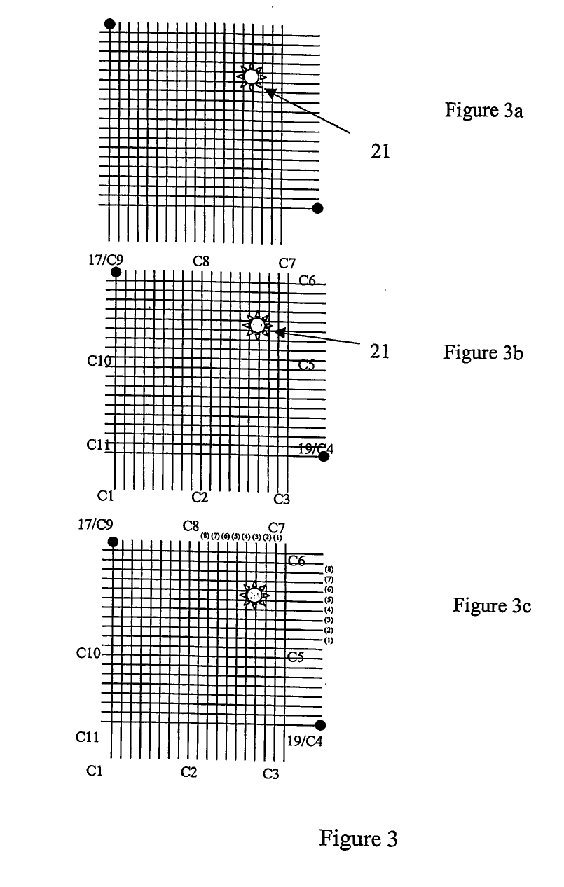

FIGS. 3a-3c show the sensor array of FIG. 1 identifying a structural event,

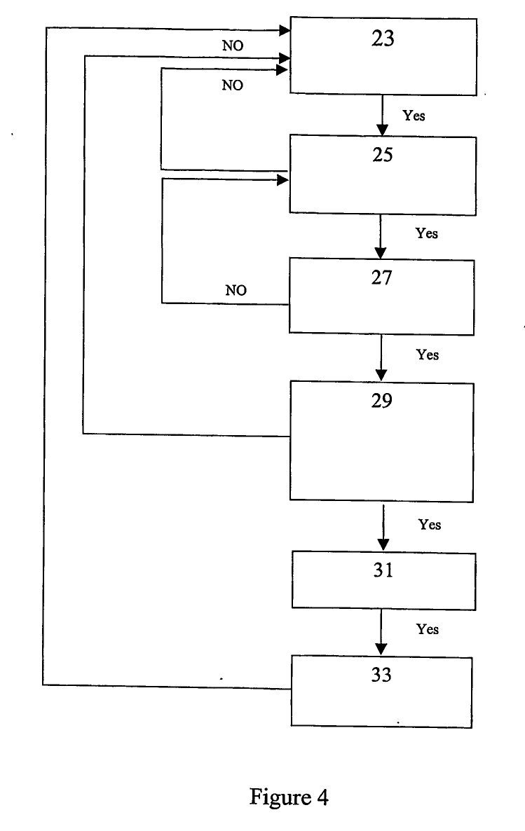

FIG. 4 shows a flowchart illustrating the logic of the interrogation software.

Turning to FIG. 1 a sensor (1) according to the present invention is shown. The sensor comprises a combination of a coarse electrical grid (3) of pitch A and a fine electrical grid (5) of pitch B (pitch A>pitch B). The sensor is shown to be a grid in this example but the skilled person will appreciate that other sensor geometries are possible depending on, amongst other factors, the structure to be monitored. The various grid lines all incorporate a monitor node (7) which is electrically attached to the interrogation system (not shown).

The grid pitches and line thicknesses of the grid lines can be varied according to the required application and also the required monitoring resolution on the structure of interest. However, in a typical configuration the coarse grid has a line thickness of 0.2 mm and a pitch A=20 mm. The fine grid has line thickness of 0.2 mm and pitch B=2 mm.

Typically, the resistance per unit length of the of the coarse grid is significantly higher than that for the fine grid. For example, a coarse grid of 200 mm×200 mm results in a typical resistance of 2 kΩ for the coarse grid length and 20Ω for the fine grid length. Hence, the ratio of the resistance per unit length of the coarse grid to the resistance per unit length of the fine grid is 100:1.

The sensor can either be integrated into the structure to be monitored during manufacture, e.g. it could be embedded within a composite material during construction, or it can be retro-fitted to existing structures in the form of a patch or appliqué. In the latter case the sensor array can be deposited onto a film substrate (for example a polyimide film substrate) which can then be attached to the structure to be monitored. An alternative would be to print the sensor array directly on to a cloth from which it is to be manufactured (see the co-pending applications WO02/099162 and WO02/099163 for suitable printing techniques).

FIG. 2 shows the sensor of FIG. 1 and the associated sensor interrogation hardware, collectively the sensor array. The sensor (1) is connected via edge connectors (9) to a plurality of multiplex units (11). The mulitplex units (11) in turn feed into a PC (13) running software which interrogates the sensor array to identify and locate damage. Optionally the output of the PC (13) can be sent to a remote monitoring station (15) and microcontrollers can be used to augment or replace the multiplexing operations, permitting greater scope for scaling the system and incorporating the sensor into the architecture of other systems. The system can be scaled in accordance with the geometry of the grid or by using a number of modular grid sensors in conjunction with each other. In the latter case, it is possible to assess the response of the distinct grids locally, using microprocessor technology, and co-ordinate the global response via a central control unit.

The number of multiplex units (11) above is determined by the speed response requirements of the system, the number of grid connections and the required resolution. In the case of an embedded sensor the PCB connectors could be replaced by drilling down into the structure and connecting via conductive bolts or conductive adhesive, depending on the resolution required by the application.

FIG. 3 illustrates how the sensor (1) locates a structural event (such as an impact). In use the interrogation software continuously monitors the sensor (1) by monitoring the resistance between two master nodes (17) and (19) on the electrical grid. In order to reduce processing load these master nodes are widely spaced. Following a strain event (21) the resistance between node (17) and node (19) changes.

The interrogation software then checks the coarse grid. FIG. 3b shows the coarse grid nodes, C1, C2, C3, C4 (which is also master node (19)), C5, C6, C7, C8, C9 (also master node (17)), C10 and C11. By checking the resistance change between C9 and C1, C2, C3, C5, C6, C7, C8, C10 and C11 (i.e. all coarse nodes except master nodes) and C4 and C1, C2, C3, C5, C6, C7, C8, C10 and C11 the interrogation software can isolate the location of the structural event (21) to a particular coarse grid square (in this example the upper right square).

The interrogation then checks the fine grid by a similar process. FIG. 3b shows the fine grid nodes for the area in question, C5_1, C5_2, C5_3, C5_4, C5_5, C5_6, C5_7 and C5_8 and also C7_1, C7_2, C7_3, C7_4, C7_5, C7_6, C7_7 and C7_8. By using C5 and C8 as the base points changes in the resistance between C5 and C7_2, C7_3, C7_4 and between C8 and C5_4, C5_5, C5_6, C5_7 enable the interrogation software to locate the structural event (21).

The size of the resistance change can be related to the strain experience by the structure and a determination of the size of damage can be made, along with an assessment of how that damage will influence the performance of the structure. e.g. by reference to a look up reference table.

Determination of the likely damage enables the system to send an advisory communication to the remote monitoring station (15). Following this communication the system updates the current structural state to the reference structural state and reverts to monitoring the master nodes (17) and (19).

FIG. 4 summarises the logic steps that the interrogation software follows after a structural event. The initial state (23) is to monitor the resistance across the master nodes of the sensor. If the master nodes indicate that damage has occurred then the system moves to monitoring the resistance across the coarse grid (25). If the coarse grid fails to locate the area of damage then the system reverts to state (23). If the coarse grid indicates damage then the system moves to monitor the fine grid (27). If the fine grid analysis fails to locate the area of damage then the system reverts to the coarse grid analysis (25). However, if the fine grid analysis (27) pinpoints the damage location then the change in resistance can be assessed against a reference table to determine whether an advisement message needs to be sent to a remote monitoring station. If no, then the system reverts to state (23) but if yes then the system advises the remote monitoring station (e.g. in the application of aircraft structure monitoring the advisement message will probably be sent to the cockpit). Finally the system proceeds to update the current structural state to become the new reference state (33) and the system then loops back to monitoring the master nodes once more.

The above description outlines the operation of the sensor in an active mode. However, if real-time monitoring and feedback is not required, it is also possible to store the response of the sensor in memory for download at a time convenient for the user. In an aircraft, for example, this might necessitate the use of a ground based data interpretation system serving a similar purpose to the remote monitoring system identified above.

The sensor described in the above embodiments monitors changes in resistance across the conductive mesh arising in response to the strain upon the structure that is being monitored. The skilled person will appreciate however that different physical properties will also affect resistance across the mesh and the sensor's operation could be based upon these properties.

For example, for a porous structure, changing moisture content could affect the resistance and the sensor could effectively be used as a moisture sensor.

1. A sensor (1) for monitoring a structure comprising a network of interconnected electrical pathways, wherein an electrical property of the pathways is arranged in use to be responsive to a change in a predetermined physical property of the structure.

2. A sensor (1) as claimed in claim 1 wherein the electrical property comprises at least one of the impedance, the capacitance, the inductance and the resistance of the pathways.

3. A sensor (1) as claimed in claim 1 or 2 wherein the sensor is responsive to at least one of a strain on the structure and the moisture content of the structure.

4. A sensor (1) as claimed in any of the preceding claims wherein the network comprises a first sub-network (3) of pathways and a second sub-network (5) of pathways, the first and second sub-networks being superposed.

5. A sensor (1) as claimed in claim 4 wherein the first and second sub-networks (3, 5) are periodic.

6. A sensor (1) as claimed in claim 5 wherein the periodicity of the first and second sub-networks (3, 5) is different.

7. A sensor (1) as claimed in any of the preceding claims wherein the pathways are arranged as a plurality of intersecting rows and columns.

8. A sensor (1) as claimed in claim 7 wherein the rows are arranged perpendicular to the columns.

9. A sensor (1) as claimed in claim 7 or 8 wherein the pathway within each row is connected electrically to the pathway within each column at the intersections thereof.

10. A sensor (1) as claimed in any of the preceding claims further comprising a support substrate.

11. A sensor array for monitoring a structure comprising a sensor (1) according to any of claims 1 to 10 and a signal processing means (13) arranged in use to monitor an electrical property of the pathways, the signal processing means (13) being electrically connected to each end of each electrical pathway.

12. A sensor array as claimed in claim 11 wherein the signal processing means (13) continuously monitors the electrical property of a pre-determined sub-set of the available electrical pathways.

13. A sensor array as claimed in claim 12 wherein the signal processing means (13) progressively monitors the electrical property of further electrical pathways following a change in the electrical property of the pre-determined sub-set of pathways.

14. A sensor array as claimed in any of claims 11-13 wherein the signal processing means (13) assesses changes in the electrical property of the sensor (1) pathways to determine when damage to the structure has occurred.

15. A composite material comprising a sensor (1) as claimed in any of claims 1 to 10.

16. A composite material as claimed in claim 15 wherein the sensor (1) is embedded within the composite material.

17. An aircraft structure comprising a composite material according to claim 15 or claim 16.

18. An aircraft structure as claimed in claim 17 wherein the sensor (1) has a secondary use as a lightning conductor.

19. A method of monitoring the structural health of a structure, having a sensor (1) according to any of claims 1-10, comprising the steps:
(i) monitoring an electrical property of the sensor (1),
(ii) measuring changes in the monitored electrical property in order to identify a structural event across the sensor (1),
(iii) assessing the level of damage by comparing the measured change in the electrical property with that for known strain events, and
(iv) sending an alert in the event the damage is assessed as significant.

20. A method as claimed in claim 19 comprising, upon detection of a change in the monitored electrical property following a structural event across the sensor (1), the additional step of measuring the electrical property across specific electrical pathways in order to locate the structural event.

21. A method as claimed in claim 20 comprising iteratively selecting specific electrical pathways arranged progressively closer to one another within the sensor (1) in order to locate the structural event.

22. A method as claimed in any of claims 19-21 wherein the monitored electrical property comprises the resistance of the sensor (1).
